(19) United States
(12) Patent Application Publication
(10) Pub. No.: US 2017/0356892 A1
(43) Pub. Date: Dec. 14, 2017

(54) SYSTEM AND METHOD OF AUTOMATING A TITRATION

(71) Applicant: Shawn Matthew Martin, Fort Mill, SC (US)

(72) Inventor: Shawn Matthew Martin, Fort Mill, SC (US)

(21) Appl. No.: 15/179,019

(22) Filed: Jun. 10, 2016

(51) Int. Cl. G01N 31/16; G01N 35/00; G01N 35/10

(52) U.S. Cl. CPC G01N 31/16; G01N 35/10; G01N 35/00871; G01N 35/0099; Y10S 901/09

(57) ABSTRACT

A system for titrating a solution is provided. The system includes a robotic arm, a titrator, a solution pump, an infusion pump, a scale, and an Autonomous cup dryer Carousel/Carriage. The system further includes a computer having a memory and a processor. The computer may be a programmable logic controller. The processor of the computer activates the solution pump to pump a solution into a drip chamber, directs the robotic arm to place a cup on the scale, activates the infusion pump to drip the solution from the drip chamber into the cup until a threshold weight has been reached, and directs the robotic arm to transport the cup to the titrator.

### BACKGROUND OF THE INVENTION

The present invention relates to titration and, more particularly, to a system and method of automating a titrator.

Titration is a technique where a solution of known concentration is used to determine the concentration of an unknown solution. Typically, the titrant (the known solution) is added from a burette to a known quantity of the analyte (the unknown solution) until the reaction is complete. To perform a titration, a lab technician is needed to gather and weigh solutions, wash cups, take results and make line adjustments to liquids that require titration or other lab testing. The current system includes unnecessary delays and a misuse of man hours.

As can be seen, there is a need for an improved automated system for titrating a solution.

### SUMMARY OF THE INVENTION

In one aspect of the present invention, a system for titrating a solution, wherein the system comprises: a robotic arm; a titrator; a solution pump; an infusion pump; a scale; and a computer comprising a memory and a processor, wherein the processor activates the solution pump to pump a solution into a drip chamber; directs the robotic arm to place a cup on the scale; activates the infusion pump to drip the solution from the drip chamber into the cup until a threshold weight has been reached; and directs the robotic arm to transport the cup to the titrator, wherein the solution is titrated.

In another aspect of the present invention, a method of titrating a solution comprises the steps of: pumping a solution into a drip chamber via a solution pump; dripping the solution from the drip chamber into a cup via an infusion pump, wherein the cup is on a scale; transporting the cup to a titrator once a threshold weight has been detected, wherein the cup is transported from the scale to the titrator by a robotic arm controlled by a computer, and the solution is titrated by the titrator.

These and other features, aspects and advantages of the present invention will become better understood with reference to the following drawings, description and claims.

### BRIEF DESCRIPTION OF THE DRAWINGS

FIG. 1 is flow chart illustrating a method of an embodiment of the present invention; and

FIG. 2 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a system and method of automating a titration system. The solution pump may pump the chemical, from the supply, to be tested by the titrator through a supply line. The supply line thickness should be as thin as possible to avoid wasted solution and should depend on the length of the line to the titrator. A catch test of the pump to properly fill the drip chamber is performed upon installation to avoid over and underuse of solution.

The drip chamber receives the solution. Once adequately filled, the robotic arm is transported to the scale by the robotic arm. Once over the scale, the drip chamber begins the drip process by means of an infusion pump. A flow preventer, by means of the programmable logic computer, shall release only a hundredth of what the necessary aim weight needs. For example, if an aim weight for the titration is 0.50-0.60, once the solution has been measured to 0.49, one more drip of 0.01 may be delivered. The programmable logic controller then stops the drip once it has achieved aim weight.

The robotic arm may then transport the drip chamber back to the drain for the clean cycle. Deionized water is pumped through to clean the supply line and the drip chamber over a drain. Alternatively, the drip chamber may remain above the infusion pump, and the deionzed water may run through the drop chamber and the infusion pump.

In the sequence, the Programmable Logic Controller (PLC) shall commence as follows:

1. Sample cup is delivered to the scale. Once recognized by the Programmable Logic Controller that the Sample cup is successfully in place, the scale may be zeroed.

2. Solution pump starts and stop once the desired amount has reached the drip chamber.

3. Robotic arm transports the drip chamber to the scale directly over the sample cup. Infusion pump drips the solution from the drip chamber until the aim sample weight is achieved, stop dripping, and move back to the drain position.

4. Clean cycle from the Deionized Water Pump is initiated.

5. The software recognizes the sample is ready, transfer the weight and name the sample by the location the solution was retrieved from the Bias Manager. Robotic arm, takes the cup from the scale and moves it to the titrator. Once recognized in place, the sample starts.

6. Once the sample is complete, the results trigger a reaction, through the PLC, to increase or decrease the pump or auger that feeds the additive which needs tested for. For example Chemical A is water and Chemical B is the additive. An aim percentage of Chemical B is 2.0%. By means of a catch test to the auger or pump, this should be a multiple point of speeds catch test to figure your slope. Once determined an R2 also will be figured to determine the accuracy of the catch test. A Y is also figured which converts to hertz or speeds to know how much to correct to achieve aim through the PLC. With the slope, or by means of a loss in weight system, makes the adjustment from the results of the titration test.

7. After the sample is complete, the robotic arm removes the used sample cup from the Titrator and dumps the contents into the drain. The robotic arm may then move the cup to the spray nozzle.

8. The spray nozzle sprays and cleans the titration cup.

9. The Robotic arm moves the cup to the Autonomous Titrator Cup Dryer Carriage.

10. The Autonomous Titrator Cup Dryer Carriage may include the following. Once the washed cup is placed on the cup peg of the Autonomous Titrator Carriage, it is continuous pegs that move in a spiral from top to the bottom, then back to the top, giving the washed cups time to dry. It moves through a rail system that goes through the entrance, where the carriage is moved by a chain driven inside the dryer. It exits through the bottom of the dryer. A reservoir is underneath the Titrator to catch all dripping water by the cups and is connected to the drain system. The cups exit through the bottom upside down and the whole system gives them time to dry before it gets to the top where robotic arm replenishes the scale with a clean cup. The dried cups are taken by the robotic arm to move to the scale for the next sample.

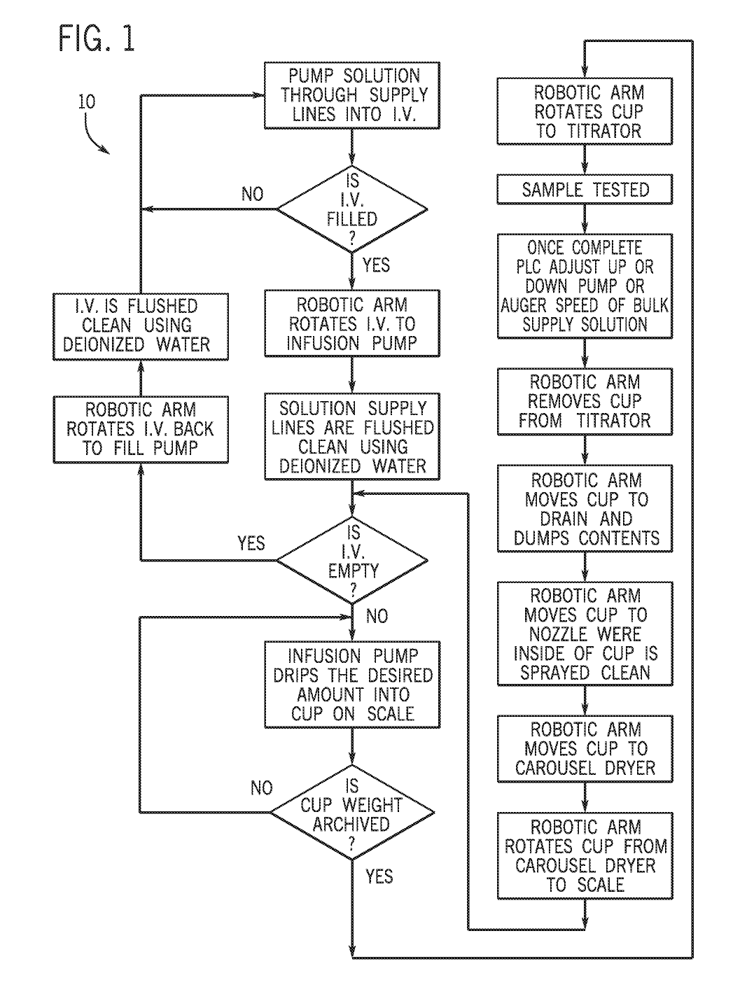

Referring to FIG. 1, the present invention includes a method 10 of titrating a solution. The method may include the following steps: pumping a solution into a drip chamber via a solution pump; dripping the solution from the drip chamber into a cup via an infusion pump, wherein the cup is on a scale; and transporting the cup to a titrator once a threshold weight has been detected. The cup is transported from the scale to the titrator by a robotic arm controlled by a computer. The solution is then titrated by the titrator. In certain embodiments, the drip chamber is transported from the solution pump to the infusion pump by the robotic arm after the solution is pumped into the drip chamber.

The method steps may further include: transporting the drip chamber to a deionized water pump by the robotic arm after the threshold weight has been reached; and pumping a deionized water into the drip chamber via the deionized water pump. In certain embodiments, the deionized water and the solution are pumped through a common supply line. Therefore, the solution is flushed from the common line while the deionized water is pumped into the drip chamber.

The method of the present invention may further includes the steps of: dumping the solution from the cup by the robotic arm after the solution has been titrated; spraying the cup with a cleaning solution via a spraying mechanism; and transporting the cup to a drying rack via the robotic arm. The drying rack may be a carousel dryer. The robotic arm may rotate a cup from the carousel dryer to the scale to start the steps over again.

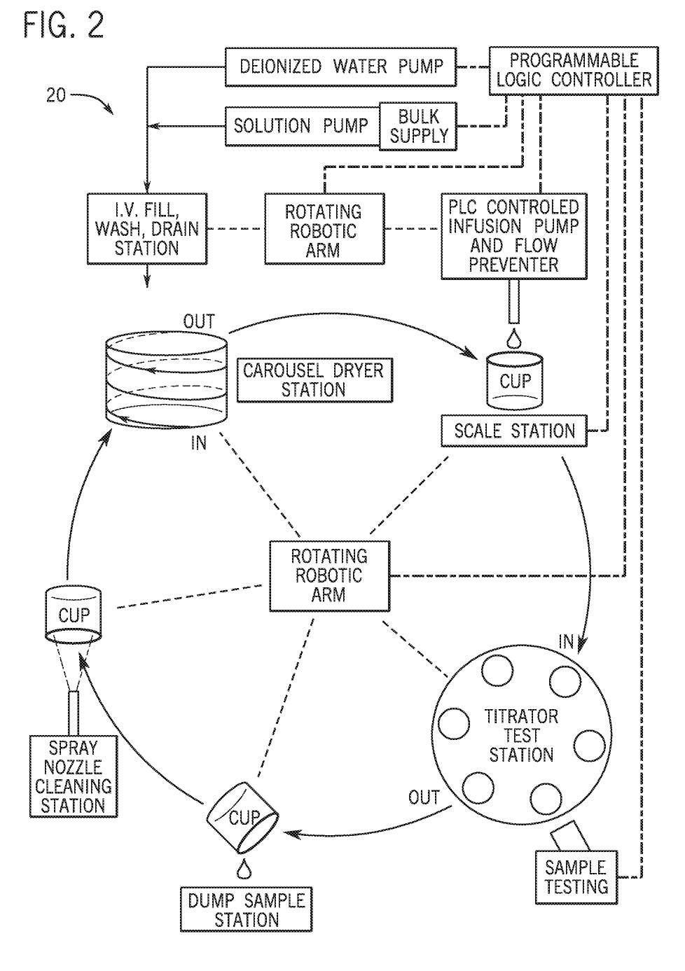

Referring to FIG. 2, the present invention includes a system 20 for titrating a solution. The system includes a robotic arm, a titrator, a solution pump, an infusion pump and a scale. The system further includes a computer having a memory and a processor. The computer may be a programmable logic controller. The processor of the computer activates the solution pump to pump a solution into a drip chamber, directs the robotic arm to place a cup on the scale, activates the infusion pump to drip the solution from the drip chamber into the cup until a threshold weight has been reached, and directs the robotic arm to transport the cup to the titrator. In certain embodiments, the processor directs the robotic arm to transport the drip chamber from the solution pump to the infusion pump after the solution is pumped into the drip chamber.

The system of the present invention may further include a deionized water pump. In such embodiments, the processor directs the robotic arm to transport the drip chamber to the deionized water pump after the threshold weight has been reached, and activates the deionized water pump to pump a deionized water into the drip chamber. In certain embodiments, the deionized water and the solution are pumped through a common supply line. Therefore, the solution is flushed from the common line while the deionized water is pumped into the drip chamber.

The system of the present invention may further include a spraying mechanism and a drying rack. The processor may further direct the robotic arm to dump the solution from the cup after the solution is titrated, activates the spraying mechanism to spray the cup with a cleaning solution, and directs the robotic arm to transport the cup to the (Autonomous cup drying carriage) drying rack.

As illustrated in FIG. 2, the robotic arm may be a rotating robotic arm. The rotating robotic arm may rotate about a longitudinal axis of the robotic arm. In such embodiments, a plurality of stations may be disposed circumferentially about the robotic arm. For example, a scale station, a titrator test station, a dump sample station, a spray nozzle cleaning station and a carousel dryer station may encircle the rotating robotic arm. Therefore, the robotic arm may rotate about the longitudinal axis to transport the cup from the scale to the titrator, to the drain, to the spray nozzle, to the dryer and then back to the scale.

It should be understood, of course, that the foregoing relates to exemplary embodiments of the invention and that modifications may be made without departing from the spirit and scope of the invention as set forth in the following claims.

What is claimed is:

1. A system for titrating a solution, wherein the system comprises:
a robotic arm;
a titrator;
a solution pump;
an infusion pump;
a scale; and
a computer comprising a memory and a processor/Programmable Logic Controller,
activates the solution pump to pump a solution into a drip chamber;
directs the robotic arm to place a cup on the scale;
activates the infusion pump to drip the solution from the drip chamber into the cup until a threshold weight has been reached; and
directs the robotic arm to transport the cup to the titrator, wherein the solution is titrated.

2. The system of claim 1, further comprising a spraying mechanism and a drying rack (Autonomous cup dryer Carousel/Carriage), wherein the processor
directs the robotic arm to dump the solution from the cup after the solution is titrated;
activates the spraying mechanism to spray the cup with a cleaning solution; and
directs the robotic arm to transport the cup to the drying rack.

3. The system of claim 1, wherein the processor/Programmable Logic Controller
directs the robotic arm to transport the drip chamber from the solution pump to the infusion pump after the solution is pumped into the drip chamber.

4. The system of claim 1, further comprising a deionized water pump, wherein the processor
directs the robotic arm to transport the drip chamber to the deionized water pump after the threshold weight has been reached; and
activates the deionized water pump to pump a deionized water into the drip chamber.

5. The system of claim 4, wherein the deionized water and the solution are pumped through a common supply line, wherein the solution is flushed from the common line while the deionized water is pumped into the drip chamber.

6. A method of titrating a solution comprising the steps of:
pumping a solution into a drip chamber via a solution pump;
dripping the solution from the drip chamber into a cup via an infusion pump, wherein the cup is on a scale;
transporting the cup to a titrator once a threshold weight has been detected, wherein
the cup is transported from the scale to the titrator by a robotic arm controlled by a computer, and
the solution is titrated by the titrator.

7. The method of claim 6, further comprising the steps of:
dumping the solution from the cup by the robotic arm after the solution has been titrated;
spraying the cup with a cleaning solution via a spraying mechanism; and
transporting the cup to a drying rack via the robotic arm.

8. The method of claim 6, further comprising the step of:
transporting the drip chamber from the solution pump to the infusion pump by the robotic arm after the solution is pumped into the drip chamber.

9. The method of claim 6, further comprising the steps of:
transporting the drip chamber to a deionized water pump by the robotic arm after the threshold weight has been reached; and
pumping a deionized water into the drip chamber via the deionized water pump.

10. The method of claim 9, wherein the deionized water and the solution are pumped through a common supply line, wherein the solution is flushed from the common line while the deionized water is pumped into the drip chamber.
